(19) United States
(12) Patent Application Publication
(10) Pub. No.: US 2017/0148552 A1
(43) Pub. Date: May 25, 2017

(54) WIRE HARNESS SHEET

(71) Applicant: YAZAKI CORPORATION, Tokyo (JP)

(72) Inventors: Shota MOCHIZUKI, Shizuoka (JP); Hiroshi ICHIKAWA, Shizuoka (JP); Kazuya TAKEUCHI, Shizuoka (JP)

(73) Assignee: YAZAKI CORPORATION, Tokyo (JP)

(21) Appl. No.: 15/421,846

(22) Filed: Feb. 1, 2017

Related U.S. Application Data
(63) Continuation of application No. PCT/JP2015/074260, filed on Aug. 27, 2015.

(30) Foreign Application Priority Data
Aug. 28, 2014 (JP) 2014-173519
Sep. 9, 2014 (JP) 2014-183131

(51) Int. Cl. H01B 17/60; B60R 16/02; H01B 3/44

(52) U.S. Cl. CPC H01B 17/60; H01B 3/441; B60R 16/0207; H01B 7/0045

(57) ABSTRACT

A wiring harness sheet (1) includes a foam (3) formed into a sheet, a film (5) provided onto one of the front and back surfaces of the foam (3), and an adhesive layer (7) provided onto another of the front and back surfaces of the foam (3). A hardness of the film (5) is set at a Shore hardness within a range of A60 to A92.

### CROSS REFERENCE TO RELATED APPLICATIONS

This application is a Continuation of PCT Application No. PCT/JP2015/074260, filed on Aug. 27, 2015, and claims the priority of Japanese Patent Application No. 2014-173519, filed on Aug. 28, 2014, and Japanese Patent Application No. 2014-183131, filed on Sep. 9, 2014, the content of both of which is incorporated herein by reference.

### BACKGROUND

Technical Field

The present invention relates to a wire harness sheet.

Related Art

Among conventional wire harness sheets is a wire harness sheet known as including: a sheet base material as a foam formed in the shape of a sheet; a front surface material as a film provided onto one of the front and back surfaces of the sheet base material; and an adhesive layer provided onto the other of the front and back surfaces of the sheet base material (see Japanese Patent Application Publication No. 2013-168322).

In the wire harness sheet, the sheet base material is made of a PP (polypropylene) foamed material; the front surface material is made of a PP film, a PET (polyethylene terephthalate) film, or the like; and the adhesive layer is made of a self-adhesive layer which is capable of adhering to itself by bringing its adhesive surfaces into contact with each other, without using glue or bonding tape.

The wire harness sheet is wrapped round the multiple wires such that the adhesive layer and the front surface material work respectively as the inner surface and the outer surface; and the adhesive layer is made to adhere to itself by aligning the adhesive surfaces of the adhesive layer to each other. Thereby, the wire harness sheet bundles and protects the wires.

### SUMMARY OF THE INVENTION

Meanwhile, in the wire harness sheet as shown in Japanese Patent Application Publication No. 2013-168322, the front surface material used as the film is a so-called stretched sheet which is manufactured by: cooling a raw sheet extruded from a die using an extruder; and thereafter heat-stretching the thus-cooled raw sheet using a stretching apparatus. The hardness of this stretched sheet is set at a Shore hardness of A97.

In the case where the film like this is applied to a wire harness sheet, the film working as the outer surface of the wire harness sheet may interfere with members around the film due to vibrations and the like, and thus make abnormal noises, while the vehicle is running.

With this taken into consideration, an object of the present invention is to provide a wire harness sheet capable of inhibiting the occurrence of abnormal noises which result from the interference with the nearby members.

A wire harness sheet according to an aspect of the present invention includes a foam formed into a sheet, a film provided onto one of front and back surfaces of the foam, and an adhesive layer provided onto another of the front and back surfaces of the foam. A hardness of the film is set at a Shore hardness within a range of A60 to A92.

In this wire harness sheet, the hardness of the film is set at a Shore hardness within a range of A60 to A92. This makes it possible to make the film flexible, to allow the film to absorb impact which results from interference of the film and members around the film with each other, and accordingly to inhibit the film from making an abnormal noise as the result of the interference of the film and the members around the film with each other.

Furthermore, the flexibility of the film makes the wire harness sheet easy to curve, and to accordingly assemble the wire harness sheet and multiple wires together with improved ease. In addition, the flexibility of the film makes the film less likely to come off the foam.

Accordingly, the wire harness sheet like this makes it possible to make the film lessen impact resulting from the interference of the film and the members around the film with each other, and to accordingly inhibit the film from making an abnormal noise as the result of the interference of the film and the members around the film with each other.

The present invention provides a wire harness sheet capable of inhibiting the occurrence of abnormal noises which result from the interference with the nearby members.

### BRIEF DESCRIPTION OF DRAWINGS

FIG. 1 is an exploded perspective diagram of a wire harness sheet of a first embodiment of the present invention;

FIG. 2 is a diagram showing an example of how to measure an abnormal noise from examples of the wire harness sheet of the first embodiment of the present invention, and their comparative examples;

FIG. 3 is a table showing results of measuring an abnormal noise from, and wear resistance of, the examples of the wire harness sheet of the first embodiment of the present invention, and their comparative examples;

FIG. 4 is a diagram showing a layer structure of a self-adhesive vinyl chloride sheet or tape of a second embodiment;

FIG. 5 is a traverse cross-sectional diagram of a wire harness of the second embodiment;

FIG. 6 is a diagram showing a step of manufacturing the wire harness of the second embodiment; and

FIG. 7 is a table showing results of self-adhesiveness, back-surface adhesiveness and plasticizer resistance.

### DETAILED DESCRIPTION

### First Embodiment

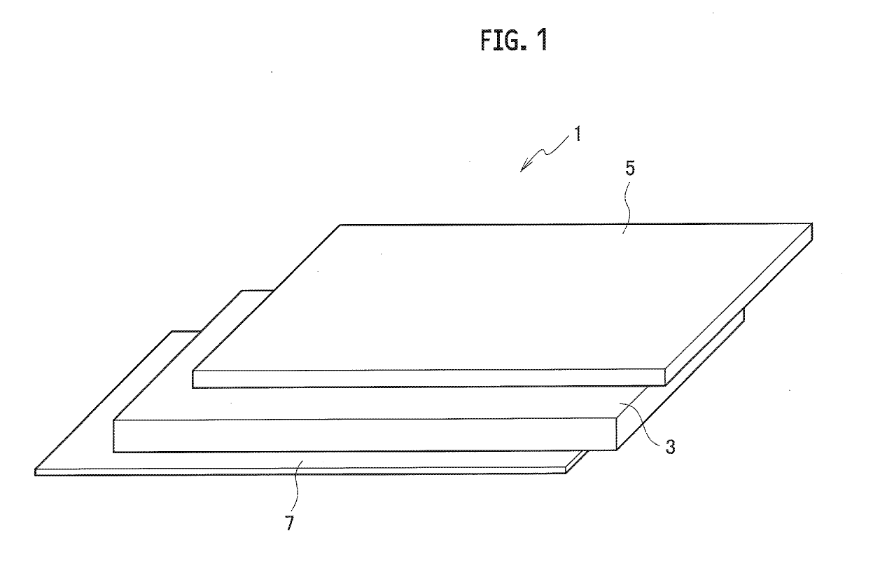

Using FIG. 1, descriptions will be provided for a wire harness sheet of a first embodiment of the present invention.

The wire harness sheet 1 of the embodiment includes: a foam 3 formed in the shape of a sheet; a film 5 provided onto one of the front and back surfaces of the foam 3; and an adhesive layer 7 provided onto the other of the front and back surfaces of the foam 3.

Furthermore, the hardness of the film 5 is set at a Shore hardness within a range of A60 to A92.

It should be noted that the wire harness sheet 1 of the embodiment is applied to an indoor wire harness placed in a door, for example.

As shown in FIG. 1, the foam 3 is made of a PP (polypropylene) foam material as a composition which is formed by adding a predetermined amount of a foaming agent to a PP resin, and is formed in the shape of a square sheet. The film 5 and the foam 3 are integrated together onto one of the front and back surfaces (in the case shown in FIG. 1, on the front surface) of the foam 3

The film 5 is made of a PP resin, and is a so-called unstretched sheet which is obtained by making a melted film from a die directly touch a cooling roll with water circulating inside the roll to cool the melted film.

The hardness of the film 5, as the unstretched sheet, is set at a Shore hardness within the range of A60 to A92. This means that the hardness of the film 5 is set at a Shore hardness of less than A97 at which films made of conventional unstretched sheets are set. For this reason, the film 5 is flexible compared with the conventional films.

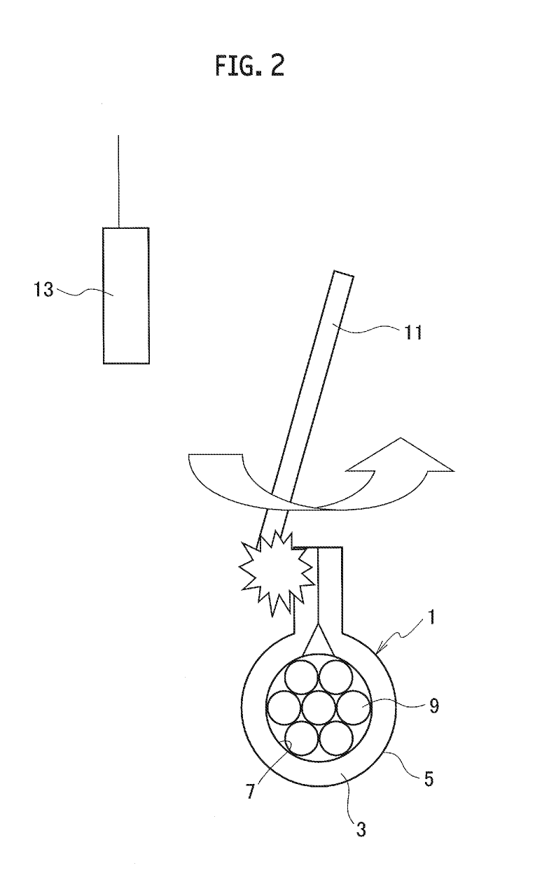

The film 5 like this works as the outer surface of the wire harness sheet 1 when multiple wires 9 (see FIG. 2) are bound together into a wire harness by: wrapping the wire harness sheet 1 round the multiple wires 9; and making the wire harness sheet 1 protect the wrapped bundle of the wires 9. For this reason, there is likelihood that the film 5 makes an abnormal noise when the film 5 and members around the film 5 interfere with each other.

With this taken into consideration, the hardness of the film 5 is set at a Shore hardness within a range of A60 to A92. This makes it possible to make the film 5 flexible compared with the conventional films, to allow the film 5 to absorb impact which results from the interference of the film 5 and the members around the film 5 with each other, and accordingly to inhibit the film 5 from making the abnormal noise.

Furthermore, the setting of the hardness of the film 5 in such a way makes it possible to make the wire harness sheet 1 easy to curve because of the flexibility of the film 5 when the wire harness sheet 1 is wrapped round the multiple wires 9, and to accordingly assemble the wire harness sheet and the wires together with improved ease.

Moreover, the flexibility of the film 5 makes it possible to inhibit the film 5 from coming off the surface of the foam 3 when the film 5 curves by doing things such as being wrapped round the multiple wires 9.

Meanwhile, the thickness of the film 5 is set at 0.10 mm or greater in a case where the hardness of the film 5 is at a Shore hardness within a range of A85 to A92. The thickness of the film 5 is set at 0.15 mm or greater in a case where the hardness of the film 5 is at a Shore hardness of A80 or greater. The thickness of the film 5 is set at 0.30 mm or greater in a case where the hardness of the film 5 is at a Shore hardness within a range of A65 to A75. The thickness of the film 5 is set at 0.35 mm or greater in a case where the hardness of the film 5 is at a Shore hardness of A60 or greater. The upper limit value of the thickness of the film 5 is set at 0.40 mm or less in order to prevent the thickness of the film 5 from decreasing the flexibility of the film 5.

The setting of the hardness of the film 5 in such a way makes it possible to prevent a decrease in the flexibility of the wire harness sheet 1 while enhancing the resistance of the wire harness sheet 1 to wear resulting from the interference of the film 5 and the members around the film 5 with each other.

The adhesive layer 7 is provided onto the other of the front and back surfaces (in the case shown in FIG. 1, on the back surface) of the foam 3 to which the film 5 like this is provided, in a way that the adhesive layer 7 and the foam 3 are integrated together.

It should be noted that the resin used for the film 5 and the foam 3 is not limited to PP. Various resins such as PE (polyethylene) and PET (polyethylene terephthalate) are usable for the film 5 and the foam 3.

The adhesive layer 7 is made of a self-adhesive layer which is capable of adhering to itself only when its adhesive surfaces are brought into contact with each other. For this reason, the wrapping of the wire harness sheet 1 round the multiple wires 9 requires no glue or bonding tape. When the wire harness sheet 1 itself is wound into a roll for the storage and conveyance purposes, no release paper or the like is needed since the adhesive surface will stick to nothing but the adhesive surface.

When the wire harness sheet 1 is wrapped round the multiple wires 9, the adhesive layer 7 made of this self-adhesive layer works as the inner surface of the wire harness sheet 1. For example, as shown in FIG. 2, the multiple wires 9 are bound together into a wire harness with two end portions of the wire harness sheet 1 stick out from the outer circumference of the multiple wires 9, and with the adhesive layers 7 in the two end portions thereof aligned to each other.

In the wire harness sheet 1 like this, the hardness of the film 5 is set at a Shore hardness within the range of A60 to A92. This makes it possible to make the film 5 flexible, to allow the film 5 to absorb impact which results from the interference of the film 5 and the members around the film 5 with each other, and accordingly to inhibit the film 5 from making an abnormal noise as the result of the interference of the film 5 and the members around the film 5 with each other.

Furthermore, the flexibility of the film 5 makes the wire harness sheet 1 easy to curve, and to accordingly assemble the wire harness sheet 1 and the multiple wires 9 together with improved ease. In addition, the flexibility of the film 5 makes the film 5 less likely to come off the foam 3.

Accordingly, the wire harness sheet 1 like this makes it possible to make the film 5 lessen the impact resulting from the interference of the film 5 and the members around the film 5 with each other, and to accordingly inhibit the film 5 from making the abnormal noise as the result of the interference of the film and the members around the film with each other.

Using the following examples, detailed descriptions will be provided for the wire harness sheet of the first embodiment. Nevertheless, the present invention is not limited by the following examples.

### EXAMPLES

For each example, the hardness of the film was set at a Shore hardness within the range of A92 to A60. For each comparative example, the hardness of the film was set at a Shore hardness within a range of A97 to A94.

In each of the examples and the comparative examples, as shown in FIG. 2, an appropriate length of wire harness sheet 1, as a test piece, was wrapped round the multiple wires 9, and the adhesive layers 7 in the two end portions of the wire harness sheet 1 were made to stick together.

A noise which the thus-stuck end portions made when hit with an aluminum bar 11 or the like was measured using a measuring device 13 such as a microphone. Incidentally, the measuring device 13 was fixed to a place higher than the stuck end portions by 40 mm, and the measurement was performed at 23° C., 0° C., and minus 40° C.

The measurement results were evaluated as follows. Test pieces which made a noise of less than 65 dB were evaluated as “good” and denoted as “∘”, while test pieces which made a noise of 65 dB or greater were evaluated as “poor” and denoted as “x”. Incidentally, 65 dB was the intensity of a noise which a vinyl sheet as a conventional film made, and was used as a criterion.

In addition, for each of the examples and the comparative examples, the thickness of the film was set within a range of 0.05 mm to 0.40 mm, while the thickness of the foam was set at 2.00 mm The resistance of the film with such a thickness to wear was measured.

The wear resistance was measured in the following sequence. An appropriate length of wire harness sheet, as a test piece, was stuck to an aluminum pipe with a diameter 10 mm The test piece was set on a wear resistance tester specified with JASO D 608. Thereafter, abrasion tape was moved over the test piece at a speed of 1500 mm/min with a load of 4.4 N applied on the test piece. The length of the tape which had moved over the test piece until the tape came into contact with the aluminum pipe was measured.

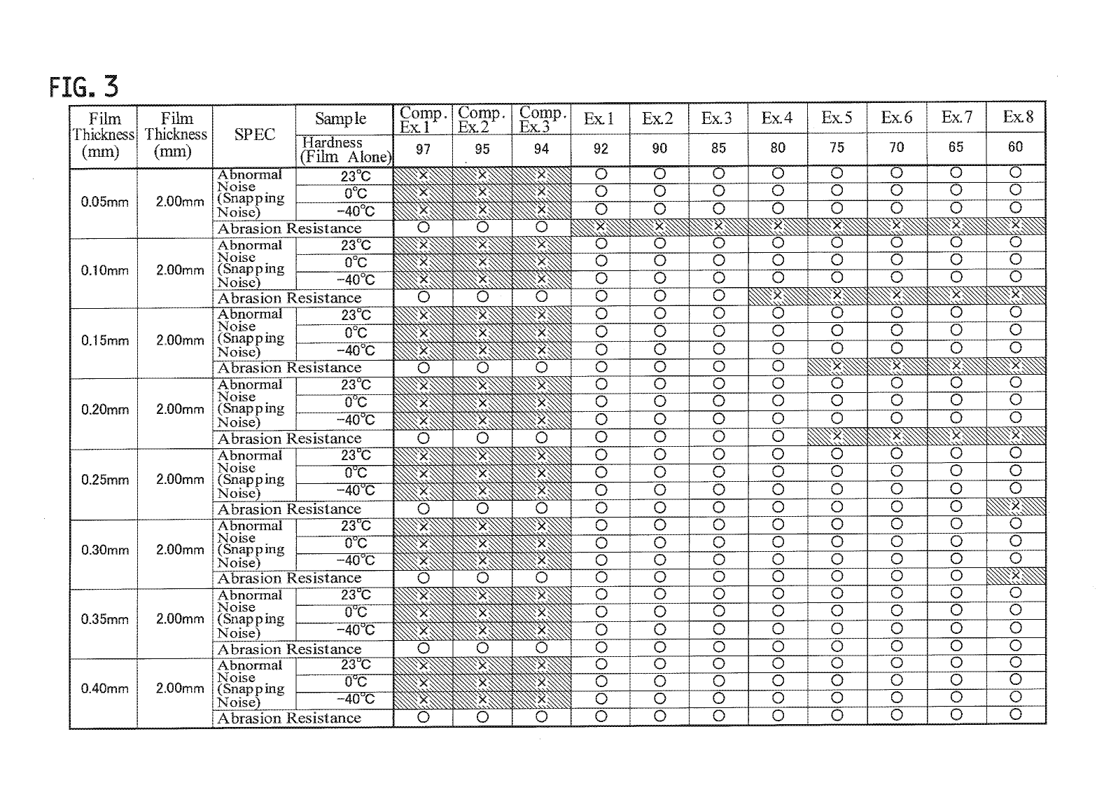

The measurement results were evaluated using a minimum wear resistance value obtained as follows. Eight data were collected by performing the above operation. An average value of the 8 data was obtained. Data equal to or less than the average value were re-averaged to obtain a value. The thus-obtained value was used as the minimum wear resistance value. In this measurement, the minimum wear resistance value was at 1000 mm. For this reason, test pieces over which the abrasion tape moved 1000 mm or greater were evaluated as “good” and denoted as “∘”, while test pieces over which the abrasion tape moved less than 1000 were evaluated as “poor” and denoted as “x”. The table in FIG. 3 shows the results of these measurements.

As clear from FIG. 3, the noise intensities of examples under the first embodiment were at less than 65 dB at each measurement temperature. Thus, the examples satisfied a criterion for the abnormal noise evaluation.

In contrast to this, the noise intensities of comparative examples were at 65 dB or greater at each measurement temperature. Thus, none of the comparative examples satisfied the criterion for the abnormal noise evaluation.

From these, it is learned that the setting of the hardness of the film at a Shore hardness of A92 or less makes it possible to make the film flexible, and to inhibit the film from making an abnormal noise as the result of the interference of the film and the members around the film.

Meanwhile, examples under the first embodiment satisfied the criterion for the wear resistance evaluation when: the hardness of the film was set at a Shore hardness within a range of A85 to A92, and the thickness of the film was set at 0.10 mm or greater; the hardness of the film was set at a Shore hardness of A80 or greater, and the thickness of the film was set at 0.15 mm or greater; the hardness of the film was set at a Shore hardness within a range of A65 to A75, and the thickness of the film was set at 0.25 mm or greater; and the hardness of the film was set at a Shore hardness of A60 or greater, and the thickness of the film was set at 0.35 mm or greater.

It should be noted that although a thicker film is more likely to satisfy the criterion for the wear resistance evaluation, the thicker film becomes less flexible, and makes the diameter of the wire harness larger when the film is attached to the wire harness, for example. For this reason, it is desirable that the upper limit of the thickness of the film be set at 0.40 mm or less.

As shown by the foregoing results, the present invention (its examples) made it possible to obtain the wire harness sheets capable of inhibiting the occurrence of the abnormal noise due to the interference of the wire harness sheets and the members around the wire harness sheets. Meanwhile, in the case where the present invention was not satisfied (in the case of the comparative examples), unattractive wire harness sheets were obtained.

It should be noted that although the adhesive layer included in the wire harness sheet of the first embodiment of the present invention is the self-adhesive layer, the adhesive layer is not limited to the self-adhesive layer, and may be one using clue, bonding tape or the like.

Furthermore, although the lower limit of the hardness of the film included in the wire harness sheet of the present invention is set at a Shore hardness of A60 or greater, the lower limit does not have to be set at a Shore hardness of A60 or greater, for example, as long as the hardness of the film is within a range which allows the film to be formed, and only the upper limit may be set at a Shore hardness of A92 or less.

### Second Embodiment

Next, based on the drawings, descriptions will be provided for a second embodiment. A wire harness sheet of the second embodiment is applied to a base material 111 serving as the foam and the film, as well as a self-adhesive layer 112 serving as the adhesive layer. The descriptions are as follows.

Referring to the drawings, specific descriptions will be hereinbelow provided for a self-adhesive vinyl chloride sheet or tape of the second embodiment.

### [Self-adhesive Vinyl Chloride Sheet or Tape]

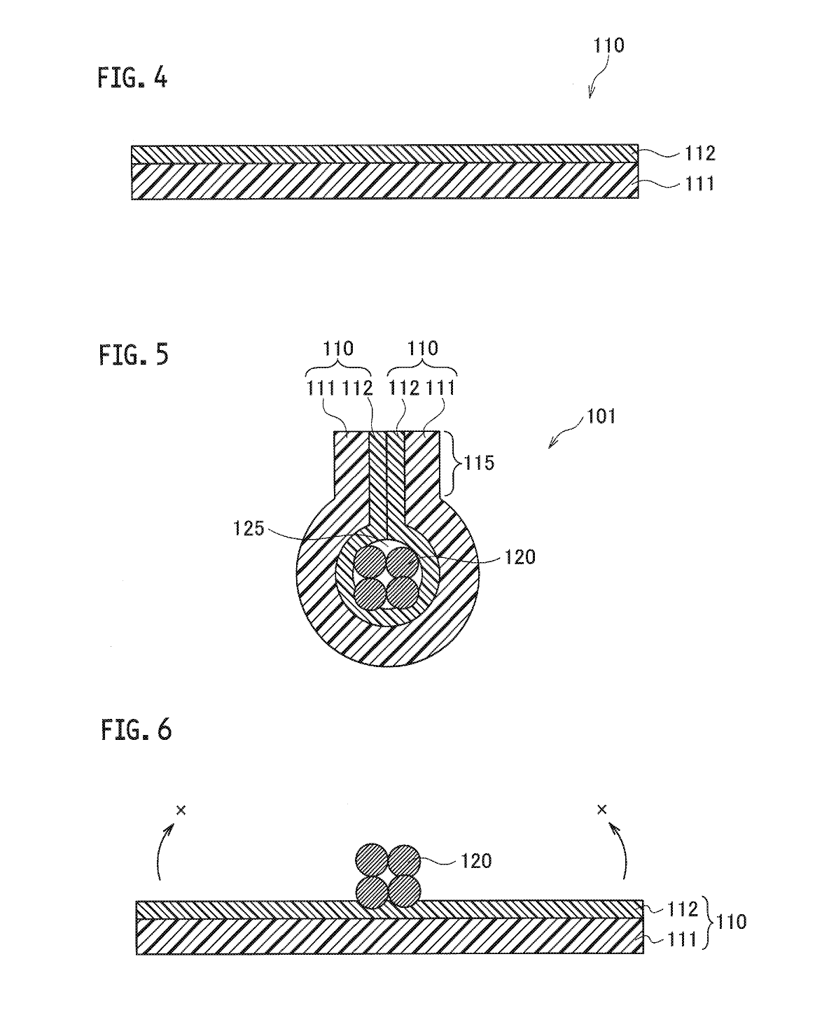

FIG. 4 is a diagram showing a layer structure of the self-adhesive vinyl chloride sheet or tape. As shown in FIG. 4, the self-adhesive vinyl chloride sheet or tape 110 of the embodiment includes: the base material 111; and the self-adhesive layer 112 provided onto one surface of the base material 111.

### (Base Material)

The base material 111 is made of a polyvinyl chloride film. A publicly-known polyvinyl chloride film is usable. For example, publicly-known polyvinyl chloride films for a base material of an adhesive tape and sheet are usable. These polyvinyl chloride films for a base material of an adhesive tape and sheet usually contain a plasticizer, and are desirable because of their inexpensiveness, excellent formability and workability, and good balance between flexibility and strength. Examples of the usable plasticizer include phthalate esters, adipate esters, polyester-based plasticizers, and trimellitate-based plasticizers such as trimellitate esters.

In general, migration of these plasticizers into an adhesive composition forming a self-adhesive layer makes the adhesive composition softer, and decreases the self-adhesiveness of the self-adhesive layer. In contrast to this, the self-adhesive vinyl chloride sheet or tape of the embodiment maintains its high self-adhesiveness even if a plasticizer migrates into the self-adhesive vinyl chloride sheet or tape, because a graft polymer itself, which forms the self-adhesive layer, has an excellent plasticizer resistance.

No specific restriction is imposed on the thickness of the base material. The base material is normally 50 to 600 μmm in thickness, and preferably 200 to 400 μm in thickness. The thickness of the base material within this range balances the flexibility and the strength of the polyvinyl chloride film well.

### (Self-Adhesive Layer)

The self-adhesive layer 112 is made of the graft polymer, and is provided onto one surface of the base material made of the polyvinyl chloride film. The graft polymer forming the self-adhesive layer is a polymer obtained by graft-polymerizing natural rubber and methyl methacrylate. In this respect, examples of the usable natural rubber include publicly-known natural rubbers, and trans-polyisoprenes.

For the graft polymer forming the self-adhesive layer, a graft ratio of the methyl methacrylate, which is defined as (the mass of the methyl methacrylate bonded to the natural rubber/the mass of the natural rubber used for the grafting)×100, is set at 30% or greater. A desirable graft ratio is set within a range of 30 to 50%, and a more desirable graft ratio is set within a range of 35 to 45%. Incidentally, the graft ratio is usually calculated from a mass ratio of the natural rubber to the MMA, which are materials to manufacture the graft polymer.

It is desirable that the graft ratio for the graft polymer be within the above range, because the graft ratio within the above makes the plasticizer resistance excellent particularly at high temperature within an approximate range of 40 to 100° C. In this respect, the plasticizer resistance means a property in which the graft polymer forming the self-adhesive layer substantially maintains the self-adhesiveness of the self-adhesive layer even if the plasticizer present in the base material migrates into the graft polymer forming the self-adhesive layer. In addition, the self-adhesiveness means a property in which the self-adhesive layer of the self-adhesive vinyl chloride sheet or tape is kept adhering to itself after the self-adhesive layer is brought into contact with, and thereby made to adhere to, itself. Incidentally, back-surface adhesiveness means a property in which the base material and the self-adhesive layer of the self-adhesive vinyl chloride sheet or tape are kept adhering to each other after they are brought into contact with, and thereby made to adhere to, each other.

Meanwhile, in a case where the graft ratio for the graft polymer is less than 30%, there is likelihood that: the low graft ratio decreases the plasticizer resistance of the graft polymer; the plasticizer in the base material makes the graft polymer softer; and eventually, the self-adhesiveness of the self-adhesive layer becomes lower. On the other hand, in a case where the graft ratio for the graft polymer is greater than 50%, there is likelihood that: the high graft ratio makes the graft polymer forming the self-adhesive layer harder; and the self-adhesiveness of the self-adhesive layer becomes insufficient.

It should be noted that in general, as the temperature becomes higher, the plasticizer more easily migrates from the base material to the self-adhesive layer, and the plasticizer resistance of the self-adhesive layer is more likely to decrease. In contrast to this, the self-adhesive layer of the embodiment exerts high plasticizer resistance at high temperature within an approximate range of 40 to 100° C. For this reason, the self-adhesiveness of the self-adhesive layer of the embodiment decreases only slightly even at such high temperature. Accordingly, the self-adhesive layer of the embodiment exhibits sufficient self- adhesiveness.

A publicly-known graft copolymerization method may be used to manufacture the graft polymer. Examples of the usable publicly-known graft copolymerization method include: a method in which natural latex rubber, and methyl methacrylate added to the natural latex rubber are graft-copolymerized under the existence of a radical polymerization starter (a latex grafting method); and a method in which natural rubber in a molten state, as well as methyl methacrylate and a radical polymerization starter are graft-copolymerized by kneading (a melting grafting method).

No specific restriction is imposed on the thickness of the self-adhesive layer made of the graft polymer. Nevertheless, the thickness of the self-adhesive layer is normally 1 to 50 μm, and preferably 15 to 40 μm. The thickness of the self-adhesive layer within this range makes the self-adhesive layer exert sufficient self-adhesiveness while the polyvinyl chloride film remains sufficiently flexible.

In a case where the thickness of the self-adhesive layer is less than 1 μm, there is likelihood that the self-adhesive layer cannot obtain sufficient self-adhesiveness. In a case where the thickness of the self-adhesive layer is greater than 50 μm, the graft polymer as the adhesive requires longer time to dry, and the self-adhesive layer becomes easy to foam. These decrease the productivity. Thus, there is likelihood that the price of the obtained self-adhesive vinyl chloride sheet or tape becomes very high.

An additive may be mixed into the graft polymer forming the self-adhesive layer depending on the necessity. Examples of the mixable additive include an antioxidant and a thickener. In this respect, the antioxidant is a substance which prevents or inhibits the oxidation of the graft polymer. Examples of the usable antioxidant include phenolic antioxidants, amine antioxidants, benzimidazole-based antioxidants, dithiocarbamate antioxidants, and phosphoric antioxidants.

Meanwhile, the thickener is a substance which increases the viscosity of the graft polymer. Examples of the usable thickener include: a thickener in the Primal Series made by Rohm & Haas Japan K. K.; and thickeners in the Carbopol Series and the Pemulen Series made by B. F. Goodrich Company. Examples of the usable thickener in the Primal Series include Primal RM-4, Primal RM-5, Primal TT-615, Primal TT-935, and Primal TT-950. Examples of the usable thickener in the Carbopol Series include Carbopol 981, Carbopol 934, Carbopol ETD2020, Cabopol EZ-1, and Carbopol Ultrez 10. Examples of the usable thickener in the Pemulen Series include Pemulen TR-1, and Pemulen TR-2. The above-mentioned thickeners may be used singly, or in combination of two or more.

Furthermore, other thickeners may be included as long as the thickeners do not impede the thickening effect of the thickeners in the Primal Series and the like. Examples of the thickeners to be used in combination with the thickeners in the Primal Series and the like include polyvinyl alcohol, carboxymethyl cellulose, and polysaccharide such as xanthan gum. These thickeners such as polyvinyl alcohol may be used singly or in combination of two or more.

For example, 0.5 to 5 parts by mass of the antioxidant is included with respect to 100 parts by mass of the graft polymer. For example, 0.5 to 2 parts by mass of the thickener t is included with respect to 100 parts by mass of the graft polymer.

### (Primer Layer)

In a case where the self-adhesive layer is formed on the surface of the base material, it is desirable that depending on the necessity, a primer layer be formed between the base material and the self-adhesive layer in order to increase the adhesion between the base material and the self-adhesive layer. In this case, the self-adhesive vinyl chloride sheet or tape includes the base material, the primer layer and the self-adhesive layer which are stacked one on another in this order. The primer layer is formed, for example by: applying a primer onto the surface of the base material; and drying the primer. Examples of the usable primer include denatured NBR primer obtained by adding acrylonitrile-butadiene rubber to the graft polymer which is obtained by graft-polymerizing the natural rubber and the methyl methacrylate.

No specific restriction is imposed on the thickness of the primer layer. The thickness of the primer layer is normally 0.01 to 10 μm, and preferably 0.1 to 0.5 μm. In a case where the thickness of the primer layer is less than 0.01 μm, there is likelihood that sufficient adhesion cannot be obtained between the base material and the self-adhesive layer. In a case where the thickness of the primer layer is greater than 10 μm, the large thickness adversely affects the forming of the self-adhesive layer on the surface of the primer layer and the adhesiveness of the self-adhesive layer. Thus, there is likelihood that the surface of the self-adhesive layer becomes uneven and the self-adhesiveness of the self-adhesive layer decreases.

### (Action)

The self-adhesive vinyl chloride sheet or tape of the second embodiment includes the self-adhesive layer having excellent plasticizer resistance. The self-adhesiveness of the self-adhesive layer is less likely to be decreased by the plasticizer in the vinyl chloride sheet base material. For this reason, in the self-adhesive vinyl chloride sheet or tape, the self-adhesive layer made to adhere to itself exerts excellent self-adhesiveness for a long period of time, as well as the self-adhesive layer and the vinyl chloride sheet base material made to adhere to each other exert excellent back-surface adhesiveness for a long period of time. Furthermore, the self-adhesive layer of the self-adhesive vinyl chloride sheet or tape exhibits excellent plasticizer resistance at the high temperature of approximately 40 to 100° C. For this reason, even if stored or used at the high temperature, the self-adhesive vinyl chloride sheet or tape exerts the excellent self-adhesiveness and the excellent back-surface adhesiveness for a long period of time.

The self-adhesive vinyl chloride sheet or tape is used as a component of a wire harness for an automobile, for example. Next, descriptions will be provided for a wire harness of the embodiment.

### [Wire Harness]

FIG. 5 is a traverse cross-sectional diagram of the wire harness. FIG. 6 is a diagram showing a step of manufacturing the wire harness. As shown in FIG. 5, the wire harness 101 of the embodiment is obtained by binding wires 120 together into a bundle using the self-adhesive vinyl chloride sheet or tape 110 of the embodiment. Multiple wires 120 are usually bound together in the bundle, and a connector is attached to the end portion of the bundle of the wires 120.

In the wire harness 101, the multiple wires 120 are bound together into the bundle by: wrapping the self-adhesive vinyl chloride sheet or tape 110 round the wires 120 in a way that the self-adhesive layer 112 of the self-adhesive vinyl chloride sheet or tape 110 comes into contact with the surfaces of the wires 120; and making two self-adhesive layers 112 self-adhere to each other in remaining parts 115 of the self-adhesive vinyl chloride sheet or tape 110 which are out of contact with the surfaces of the wires 120. Incidentally, a gap 125 is formed among the multiple wires 120, as well as between the surfaces of the wires 120 and the self-adhesive layer 112 of the self-adhesive vinyl chloride sheet or tape 110.

The wire harness 101 is manufactured as follows. To begin with, as shown in FIG. 6, the multiple wires 120 are placed on the self-adhesive layer 112 of the self-adhesive vinyl chloride sheet or tape 110. Thereafter, the two end portions of the self-adhesive vinyl chloride sheet or tape 110 are pulled upward in the directions indicated with a reference sign X in FIG. 6 to wrap the multiple wires 120 in the self-adhesive layer 112 of the self-adhesive vinyl chloride sheet or tape 110. Subsequently, as shown in FIG. 5, the two self-adhesive layers 112, 112 in the remaining parts 115 in the two end portions of the self-adhesive vinyl chloride sheet or tape 110 are brought into contact with, and thereby made to self-adhere to, each other. Thereby, the wire harness 101 is obtained.

### (Action)

The wire harness of the second embodiment binds the wires together into the bundle using the self-adhesive vinyl chloride sheet or tape which has the excellent plasticizer resistance, and which exerts the excellent self-adhesiveness and the excellent back-surface adhesiveness for a long period of time. For this reason, the wires are kept bound together in the bundle for a long period of time. Furthermore, the self-adhesive vinyl chloride sheet or tape of the wire harness of the second embodiment exhibits the excellent plasticizer resistance at the high temperature of approximately 40 to 100° C. Thus, even if used at the high temperature, the self-adhesive vinyl chloride sheet or tape can keep the wires excellently bound together in the bundle for a long period of time.

### EXAMPLES

Detailed descriptions will be hereinbelow provided for examples of the second embodiment and their comparative examples. Nevertheless, the present invention is not limited to these examples.

### Example 9

### (Production of Emulsion Adhesive Mixture for Forming Self-Adhesive Layer)

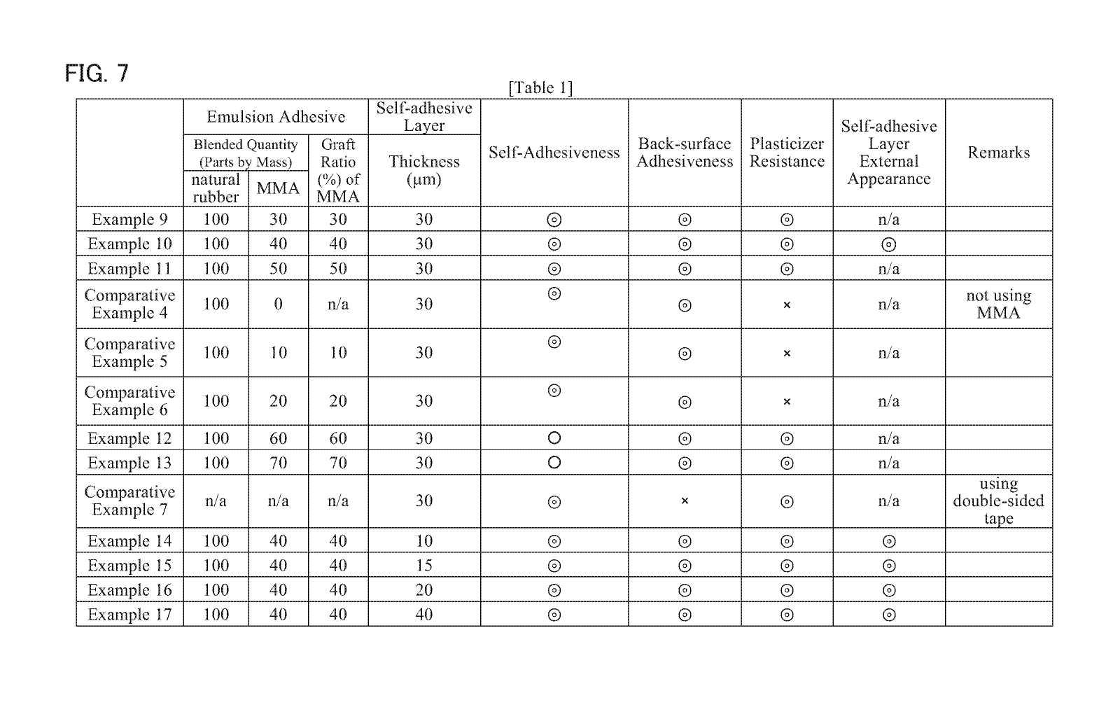

100 parts by mass of a natural rubber (NR, ULACOL made by Regitex K. K.) and 30 parts by mass of methyl methacrylate (MMA, methyl methacrylate monomer made by Kuraray Co., Ltd.) were graft-copolymerized under the existence of a radical polymerization starter to produce an emulsion adhesive (the graft polymer) with a 30-precent graft ratio. Table 1 of FIG. 7 shows the production condition and characters of the emulsion adhesive.

Then, 1 part by mass of an antioxidant (Selosol K-319 made by Chukyo Yushi Co., Ltd.), 1 part by mass of a thickener (TT615 made by Rohm & Haas Japan K. K.) were added to 100 parts by mass of the emulsion adhesive, followed by stirring using an agitator. Thereby, an emulsion adhesive mixture for forming the self-adhesive layer, containing the emulsion adhesive with the 30-precent graft ratio, was obtained.

### (Production of Self-adhesive Vinyl Chloride Sheet)

To begin with, the denatured NBR primer was applied onto the surface of the vinyl chloride sheet (with a thickness of 400 μm) as the base material, followed by drying. Thereby, the primer layer with a thickness of 0.3 μm was formed on the surface of the vinyl chloride sheet.

It should be noted that the vinyl chloride sheet was obtained by: mixing 100 parts by mass of polyvinyl chloride at a polymerization degree of 1100, 50 parts by mass of a plasticizer, 4 parts by mass of a Ca—Zn vinyl chloride composite stabilizer, 20 parts by mass of a CaCO₃ filler, a colorant, an ultraviolet absorber, and a lubricant using a Bumbary mixer until all the components were evenly dispersed; and thereafter molding the resultant mixture into a sheet with a thickness of 400 μm using a T-die molding machine. In addition, the denatured NBR primer was obtained by adding the acrylonitrile-butadiene rubber to the graft polymer which had been obtained by graft-polymerizing the natural rubber and the methyl methacrylate.

Thereafter, the emulsion adhesive mixture was applied onto the surface of the primer layer, followed by drying using an oven at 120° C. for three minutes. Thereby, the self-adhesive vinyl chloride sheet having the three-layered structure, which included the vinyl chloride sheet with the thickness of 0.4 mm, the primer layer with the thickness of 0.3 μm, and the self-adhesive layer with a thickness of 30 μm, was obtained. Test pieces were cut out from this self-adhesive vinyl chloride sheet.

### (Evaluation)

For each of the examples and their comparative examples, the self-adhesiveness, the back-surface adhesiveness and the plasticizer resistance were evaluated using the test pieces.

### <Self-Adhesiveness>

To begin with, two test pieces were prepared, and the self-adhesive layers of the respective test pieces were made to adhere to each other, followed by being left for 30 minutes. Thereafter, a force needed to unstick the two test pieces at a speed of 300 mm/min at 25° C. was measured. Directions in which the test pieces were unstuck were set in a way that an angle formed between the two unstuck test pieces was 180°.

A larger self-adhesiveness is more preferable. The following evaluation criteria were employed: a self-adhesive layer, the unsticking of whose test pieces needed a force of 10 N/20 mm or more, was evaluated as “excellent” and denoted as “\textcircled{∘}”; a self-adhesive layer, the unsticking of whose test pieces needed a force of 1 N/20 mm or more but less than 10 N/20 mm, was evaluated as “good” and denoted as “∘”; and a self-adhesive layer, the unsticking of whose test pieces needed a force of less than 1 N/20 mm, was evaluated as “poor” and denoted as “x”.

### <Back-Surface Adhesiveness>

The back-surface adhesiveness was measured in accordance with the test method A-2 of JIS C 2107 Section 11. To put it specifically, to begin with, at 25° C., a first test piece was made to adhere to a reference test plate with predetermined pressure, and a second test piece was made to adhere to the back surface (base material) of the first test piece. Thereafter, a force needed to unstick the second test piece from the back surface of the first test piece at an angle of 180° at a certain speed at 25° C. was measured.

A smaller self-adhesiveness is more preferable. With this taken into consideration, self-adhesive layers, the unsticking of whose test pieces needed a force of less than 1 N/20 mm, were evaluated as “excellent” and denoted as “\textcircled{∘}”. A self-adhesive layer, the unsticking of whose test pieces needed a force of 1 N/20 mm or more, was evaluated as “poor” and denoted as “x”.

### <Plasticizer Resistance>

Two test pieces were prepared, and the self-adhesive layer of the respective test pieces were made to adhere to each other, followed by being left in an oven at 100° C. for 168 hours. Thereafter, the two test pieces were unstuck slowly at 25° C. Directions in which the test pieces were unstuck were set in a way that an angle formed between the two unstuck test pieces was 180°. The self-adhesive layers of the respective unstuck test pieces were observed. Self-adhesive layers whose respective unstuck test pieces had not soften in a liquid state and remained in the same condition as before the test pieces were made to adhere to each other were evaluated as “excellent” and denoted as “\textcircled{∘}”. Meanwhile, self-adhesive layers whose respective unstuck test pieces had softened in a liquid state were determined as having been affected by the plasticizer, and were evaluated as “poor” and denoted as “x”.

Table 1 shows the results of the self-adhesiveness, the back-surface adhesiveness and the plasticizer resistance.

### Each of Examples 10 to 13 and Comparative Examples 4 to 6

An emulsion adhesive was produced like in Example 9, except that the production condition and characters of the emulsion adhesive were changed as shown in Table 1. Furthermore, except that the thus-produced emulsion adhesive was used, the self-adhesive vinyl chloride sheet and the test pieces were produced like in Example 9. Incidentally, an emulsion adhesive produced for Comparative Example 4 was made of natural rubber without using MMA. Using the test pieces, the self-adhesiveness, the back-surface adhesiveness and the plasticizer resistance were evaluated like in Example 9. The results of the measurements are shown in Table 1.

It should be noted that for Example 10, a self-adhesive vinyl chloride sheet finished being dried and just having been taken out of the oven was also evaluated in terms of the self-adhesive layer external appearance which means how the self-adhesive layer looked from the outside. How to evaluate the self-adhesive layer external appearance will be shown below.

### <Self-Adhesive Layer External Appearance>

Immediately after a self-adhesive vinyl chloride sheet having the three-layered structure, which had been obtained by being dried using the oven at 120° for three minutes, was taken out of the oven, the external appearance of the surface of the self-adhesive layer was observed. The following evaluation criteria were employed: a self-adhesive vinyl chloride sheet whose self-adhesive layer had a less uneven and smoother surface was evaluated as “excellent” and denoted as “\textcircled{∘}”; and a self-adhesive vinyl chloride sheet whose self-adhesive layer had a cracked and/or foamed surface was evaluated as “poor” and denoted as “x”.

For Example 10, a result of evaluating the self-adhesive layer external appearance is shown in Table 1 in addition to the results of evaluating the self-adhesiveness, the back-surface adhesiveness and the plasticizer resistance.

### Comparative Example 7

A vinyl chloride sheet with double-sided adhesive tape was produced by making the double-sided adhesive tape (Tape No. 7770 made by Teraoka Seisakusho Co., Ltd., whose support was made of non-woven fabric and coated with an acrylic-based adhesive, and which was 0.16 mm in total thickness) adhere to the surface of the vinyl chloride sheet (with the thickness of 400 μm) used for Example 9. Test pieces of this vinyl chloride sheet with double-sided adhesive tape were made like in Example 9. Using the test pieces, the self-adhesiveness, the back-surface adhesiveness and the plasticizer resistance were evaluated like in Example 9. The results of the measurements are shown in Table 1.

From Table 1, it is learned that all of the self-adhesiveness, the back-surface adhesiveness and the plasticizer resistance of self-adhesive vinyl chloride sheets which included a self-adhesive layer made of a graft polymer with a graft ratio of 30%, 40% or 50% were excellent.

### Each of Examples 14 to 17

A self-adhesive vinyl chloride sheet having the three-layered structure including the vinyl chloride sheet, the primer layer and the self-adhesive layer was obtained like in Example 10, except that the amount of the emulsion adhesive mixture to be applied was changed in order to make the thickness of the self-adhesive layer equal to a value shown in Table 1. Test pieces were cut out from this self-adhesive vinyl chloride sheet. Using the test pieces, the self-adhesiveness, the back-surface adhesiveness and the plasticizer resistance were evaluated like in Example 9.

Immediately after the self-adhesive vinyl chloride sheet was taken out of the oven, the self-adhesive layer external appearance was evaluated like in Example 10.

The results of evaluating the self-adhesiveness, the back-surface adhesiveness, the plasticizer resistance and the self-adhesive layer external appearance are shown in Table 1.

From Table 1, it is learned that the self-adhesive layer external appearance of the self-adhesive layers with a thickness within a range of 10 to 40 μm was excellent.

Although the present invention has been described using the embodiments, the present invention is not limited to these embodiments. The present invention can be variously modified within the scope of the gist of the present invention.

As described above, the self-adhesive vinyl chloride sheet or tape 110 of the second embodiment includes: the base material 111 made of the polyvinyl chloride film; and the self-adhesive layer 112 provided onto one surface of the base material 111. The self-adhesive layer is made of the graft polymer obtained by graft-copolymerizing the natural rubber and the methyl methacrylate. For the graft polymer, the graft ratio of the methyl methacrylate, which is defined as (the mass of the methyl methacrylate bonded to the natural rubber/the mass of the natural rubber used for the grafting)×100, is 30% or greater.

The self-adhesive vinyl chloride sheet or tape 110 of the second embodiment may be such that the graft ratio for the graft polymer forming the self-adhesive layer 112 is within a range of 30 to 50%.

The wire harness 101 of the second embodiment is obtained by binding the wires 120 together into the bundle using the self-adhesive vinyl chloride sheet or tape 110 of the second embodiment.

In other words, using the bundling means, the multiple wires are bound together into the wire harness 101 of the second embodiment.

Double-sided tape, binders, and adhesives have been used as the bundling means for wires. As a conventional technique related to double-sided tape, a removable pressure-sensitive recording paper sheet to be used for a post card is described in Japanese Patent Application Publication No. 2011-104840. According to this patent document, the removable pressure-sensitive recording paper sheet to be used for a post card includes a pressure-sensitive adhesive layer which is formed on both or either of the surfaces of a support made of multi-layered raw paper; the pressure-sensitive adhesive layer contains amorphous synthetic silica and a natural rubber-based pressure-sensitive adhesive; and the pressure-sensitive adhesive layer is removable after stuck to the support. In a case where the removable pressure-sensitive recording paper sheet to be used for a post card disclosed in Japanese Patent Application Publication No. 2011-104840 is used as double-sided adhesive tape, release paper is made to adhere to a surface of the pressure-sensitive adhesive layer.

However, the removable pressure-sensitive recording paper sheet to be used for a post card, disclosed in Japanese Patent Application Publication No. 2011-104840, has a problem that work efficiency is low because the release paper needs to be removed from the pressure-sensitive adhesive layer, and a problem that after removed, the release paper becomes waste. Furthermore, the removable pressure-sensitive recording paper sheet to be used for a post card is undesirable because when no release paper is applied to the double-side tape, the uncovered pressure-sensitive adhesive layer prematurely adheres to a jig or product, and because the surface state of the pressure-sensitive adhesive layer deteriorates compared with the surface state of a pressure-sensitive adhesive layer to which release paper is applied. Moreover, the removable pressure-sensitive recording paper sheet to be used for a post card, disclosed in Japanese Patent Application Publication No. 2011-104840, has a problem that its strength and water resistance are low since the support is made of the multi-layered raw paper.

Meanwhile, a technique of providing a base material made of a vinyl chloride sheet or the like with a self-adhesive layer made of an adhesive having a self-adhering property has been proposed as another bundling means which uses no release paper. Japanese Patent Application Publication No. 2001-348547 discloses an adhesive composition in which 10 to 50 parts by weight of a graft polymer is mixed as an adhesive forming the self-adhesive layer. According to this patent literature, the graft polymer is obtained by graft-copolymerizing 90 to 50 parts by weight of a natural rubber and/or an SBR (styrene butadiene rubber), a natural rubber and MMA (methyl methacrylate). The graft polymer blended in this adhesive composition contains 80 to 60 parts by weight of the natural rubber and 20 to 40 parts by weight of the MMA (methyl methacrylate) which are graft-copolymerized, and the Moony viscosity of the graft polymer is 60 to 90 Ms 1+4 (at 100° C.). According to Japanese Patent Application Publication No. 2001-348547, high unwinding force can be obtained from the adhesive composition disclosed therein.

However, for the purpose of obtaining the high unwinding force from the adhesive composition disclosed in Japanese Patent Application Publication No. 2001-348547, the content of the MMA (methyl methacrylate) in the adhesive composition is set at as low as 2 to 20% by weight. For this reason, the adhesive composition disclosed therein has a problem that: a plasticizer contained in a vinyl chloride sheet as the base material migrates into the adhesive composition forming the self-adhesive layer; and the thus-migrating plasticizer makes the adhesive composition softer, and decreases the self-adhesiveness of the self-adhesive layer. It should be noted that in general, a plasticizer more easily migrates into a self-adhesive layer as temperature becomes higher. Accordingly, when a laminated body including a vinyl chloride sheet and a self-adhesive layer is left at high temperature, the self-adhesiveness of the self-adhesive layer deteriorates easily.

For this reason, in the case where the vinyl chloride sheet base material having high strength and water resistance is used as the bundling means, double-sided adhesive tape having release paper have to be used. This causes the problem that work efficiency is poor because the release paper needs to be removed from the self-adhesive layer, and the problem that after removed, the release paper becomes waste.

Because of using no release paper, the self-adhesive vinyl chloride sheet or tape 110 of the second embodiment makes it possible to enhance the work efficiency and to reduce the waste. In addition, the self-adhesive vinyl chloride sheet or tape 110 of the second embodiment is substantially unlikely to adhere to other components since the adhesiveness is exerted only when the adhesive surfaces are brought into contact with each other. Furthermore, the self-adhesive vinyl chloride sheet or tape 110 of the second embodiment is capable of maintaining the self-adhesiveness of the self-adhesive layer 112 even if the plasticizer contained in the vinyl chloride sheet migrates into the adhesive composition forming the self-adhesive layer 112.

Because of using no release paper, the wire harness 101 of the second embodiment makes it possible to enhance the work efficiency and to reduce the waste. In addition, the wire harness 101 of the second embodiment makes the self-adhesive vinyl chloride sheet or tape 110 substantially unlikely to adhere to other components since the adhesiveness is exerted only when the adhesive surfaces of the self-adhesive vinyl chloride sheet or tape 110 are brought into contact with each other. Furthermore, the wire harness 101 of the second embodiment is capable of maintaining the self-adhesiveness of the self-adhesive layer 112 even if the plasticizer contained in the vinyl chloride sheet of the self-adhesive vinyl chloride sheet or tape 110 migrates into the adhesive composition forming the self-adhesive layer 112.

Although the foregoing descriptions have been provided for the wire harness 1, 101 according to the first and second embodiments of the present invention, the present invention is not limited to the embodiments. Needless to say, the present invention can be variously modified within the scope of the invention.

What is claimed is:

1. A wire harness sheet comprising:
a foam formed into a sheet;
a film provided onto one of front and back surfaces of the foam; and
an adhesive layer provided onto another of the front and back surfaces of the foam, wherein
a hardness of the film is set at a Shore hardness within a range of A85 to A92, and
a thickness of the film is set within a range of 0.10 mm to 0.40 mm.
